(19) United States
(12) Patent Application Publication
(10) Pub. No.: US 2023/0408771 A1
(43) Pub. Date: Dec. 21, 2023

(54) OPTICAL WAVEGUIDE DEVICE

(71) Applicant: NIPPON TELEGRAPH AND TELEPHONE CORPORATION, Tokyo (JP)

(72) Inventors: Riku TAKAHASHI, Musashino-shi, Tokyo (JP); Aya TANAKA, Musashino-shi, Tokyo (JP); Masumi YAMAGUCHI, Musashino-shi, Tokyo (JP)

(73) Assignee: NIPPON TELEGRAPH AND TELEPHONE CORPORATION, Tokyo (JP)

(21) Appl. No.: 18/033,526

(22) PCT Filed: Oct. 29, 2020
(86) PCT No.: PCT/JP2020/040549

§ 371 Date: Apr. 24, 2023

(51) Int. Cl. G02B 6/36

(52) U.S. Cl. CPC G02B 6/3608

(57) ABSTRACT

Provided is an optical waveguide device (100) including a substrate (3) formed into a plate shape, a soft material (2) having swellability, formed into a film shape, and provided on a side of one surface of the substrate, a pair of adhesive regions (B1), formed at an interface between the substrate and the soft material, in which the substrate and the soft material are adhered to each other, a non-adhesive region (B2) formed so that the substrate and the soft material are not adhered to each other between the pair of adhesive regions, a protruding part (2B) in which a channel is formed so as to protrude in the non-adhesive region in the soft material, a liquid (W) filled into the channel and having a higher refractive index than the soft material, a pair of liquid feed tubes (8) connected to both ends of the channel, and a pair of optical fibers (9) inserted into the pair of liquid feed tubes respectively, wherein an optical waveguide is formed in the protruding part, and the optical waveguide includes a cladding formed of the soft material, and includes a core formed of the liquid in the channel.

### TECHNICAL FIELD

The present invention relates to a technique of an optical waveguide device.

### BACKGROUND ART

In recent years, optofluidic technology has been actively studied in which optics is combined with microfluidic technology. Optofluidics is particularly expected to be applied in a wide range of fields of biosensors, lab-on-a-chip devices, molecular imaging, energy, and the like. As an important basic technology in optofluidics, an optical waveguide is known that propagates light in a channel. The optical waveguide includes, for example, a core material having a high refractive index and a cladding material having a low refractive index and covering the core material.

A liquid core optical waveguide (LCW) is known in which a liquid is used as a core material in an optical waveguide. Because of the use of a liquid as a core material, the LCW has unique variability so that the concentration can be freely adjusted and the shape can be freely changed. The LCW has a characteristic of being capable of propagating light with low loss even when formed into a long optical path, and can be used in an optical path conversion switch, a high-sensitivity optical sensor, and the like.

For example, Non Patent Literature 1 describes an LCW that includes a cladding formed into a channel shape using silica gel and includes a liquid core formed using water enclosed in the channel.

Non Patent Literature 2 describes an LCW that includes a cladding formed into a channel shape using polydimethylsiloxane (PDMS) and includes a liquid core formed using dimethyl sulfoxide (DMSO) enclosed in the channel. In particular, PDMS is one of the materials frequently used in microfluidics. PDMS has plasticity and processability for easy processing, and many methods have been proposed for easily producing channels having various shapes using PDMS. If PDMS is used for forming a channel, the channel only enclosing a liquid core can be used as an optical waveguide, and has very high expandability.

Non Patent Literature 3 proposes a liquid-liquid optical waveguide (liquid-core/liquid-cladding waveguide: L2WG) including a laminar flow of two liquids, that is, a liquid core and a liquid cladding in a channel in order to take advantage of the variability of the liquid core. If the L2WG is used, the shape of the optical waveguide is changed by adjusting the flow rate of the liquid, and thus the performance can be controlled.

### CITATION LIST

### Patent Literature

Patent Literature 1: JP 2020-62843 A

### Non Patent Literature

Non Patent Literature 1: Yaprak Oezbakir, Alexandr Jonas, Alper Kiraz and Can Erkey “A new type of microphotoreactor with integrated optofluidic waveguide based on solid-air nanoporous aerogels” Royal society open science, 2018
Non Patent Literature 2: Fuchuan Song, Daniela Pagliero, Carlos A. Meriles “Rapid prototyping of a liquid-core waveguide in a microfluidic polydimethylsiloxane channel for optical sensing” Optical Engineering Vol. 52(4), pp. (044404-1)-(044404-5) April 2013
Non Patent Literature 3: Kang Soo Lee, Sang Youl Yoon, Kyung Heon Lee, Sang Bok Kim, Hyung Jin Sung, and Sang Soo Kim “Optofluidic particle manipulation in a liquid-core/liquid-cladding waveguide” OPTICS EXPRESS pp. 17349-17358 Vol. 20, No. 16, 16 Jul. 2012
Non Patent Literature 4: Riku Takahashi, Hiroki Miyazako, Aya Tanaka, and Yuko Ueno, “Dynamic Creation of 3D Hydrogel Architectures via Selective Swelling Programmed by Interfacial Bonding” ACS Applied Materials & Interfaces 2019, 11, pp. 28267-28277, November 2019

### SUMMARY OF INVENTION

### Technical Problem

In the optical waveguide having a channel formed using PDMS described in Non Patent Literature 2, the shape of the channel is uniquely determined. In order to change the shape of the channel formed using PDMS, a problem is to be solved that the liquid core needs to be deformed by applying an external force with an external device such as a wired pump.

The L2WG described in Non Patent Literature 3 has a problem that the channel shape is limited in order to produce a laminar flow of two liquids, and that an external pump needs to be connected in order to change the channel shape as in the LCW. Furthermore, the L2WG has a problem that unless the laminar flow of two liquids is maintained, the function as an optical waveguide cannot be maintained and the structure becomes unstable.

In view of the above circumstances, an object of the present invention is to provide an optical waveguide device that can maintain a stable structure of an optical waveguide, and can reversibly control deformation of the optical waveguide structure by changing a liquid core without a wired external device.

### Solution to Problem

An aspect of the present invention is an optical waveguide device including a substrate formed into a plate shape, a soft material having swellability, formed into a film shape, and provided on a side of one surface of the substrate, a pair of adhesive regions, formed so as to extend along a predetermined direction on the one surface at an interface between the substrate and the soft material, in which the substrate and the soft material are adhered to each other, a non-adhesive region formed so that the substrate and the soft material are not adhered to each other between the pair of adhesive regions, a protruding part in which a channel is formed so as to protrude in the non-adhesive region in the soft material, a liquid filled into the channel and having a higher refractive index than the soft material, a pair of liquid feed tubes connected to both ends of the channel, and a pair of optical fibers inserted into the pair of liquid feed tubes respectively, wherein an optical waveguide is formed in the protruding part, and the optical waveguide includes a cladding formed of the soft material, and includes a core formed of the liquid in the channel.

### Advantageous Effects of Invention

According to the present invention, it is possible to maintain a stable structure of an optical waveguide, and reversibly control deformation of the optical waveguide structure by changing a liquid core without a wired external device.

### BRIEF DESCRIPTION OF DRAWINGS

FIG. 1 is a perspective view illustrating a configuration of an optical waveguide device according to an embodiment of the present invention.

FIG. 2 is a sectional view of an optical waveguide device.

FIG. 3 is a sectional view of an optical waveguide device.

FIG. 4 is a view illustrating a method of manufacturing an optical waveguide device.

FIG. 5 is a view illustrating a method of manufacturing an optical waveguide device.

FIG. 6 is a view illustrating a method of manufacturing an optical waveguide device.

FIG. 7 is a view illustrating a method of manufacturing an optical waveguide device.

FIG. 8 is a view illustrating a method of manufacturing an optical waveguide device.

FIG. 9 is a view illustrating a method of manufacturing an optical waveguide device.

FIG. 10 is a view illustrating a method of manufacturing an optical waveguide device.

FIG. 11 is a view for observation of a state change of an optical waveguide device with a solvent.

FIG. 12 is a view for observation of a state change of an optical waveguide device with a solvent.

FIG. 13 is a view for observation of a state change of an optical waveguide device with a solvent.

FIG. 14 is a view illustrating a waveguide characteristic of an optical waveguide device in which a channel is filled with mineral oil.

FIG. 15 is a view illustrating a waveguide characteristic of an optical waveguide device in which a channel is filled with pure water.

### DESCRIPTION OF EMBODIMENTS

Embodiments of the present invention will be described in detail with reference to the drawings.

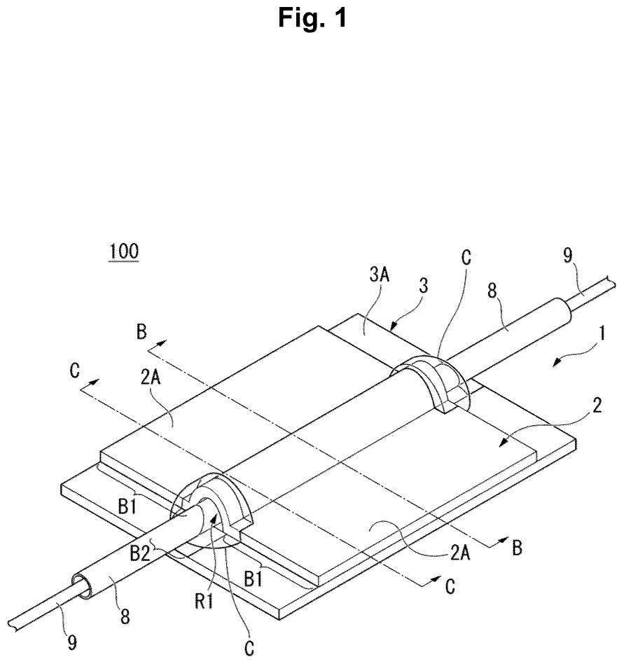

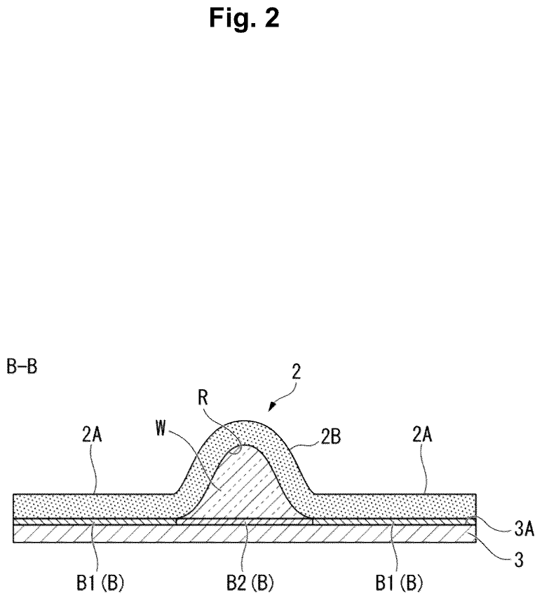

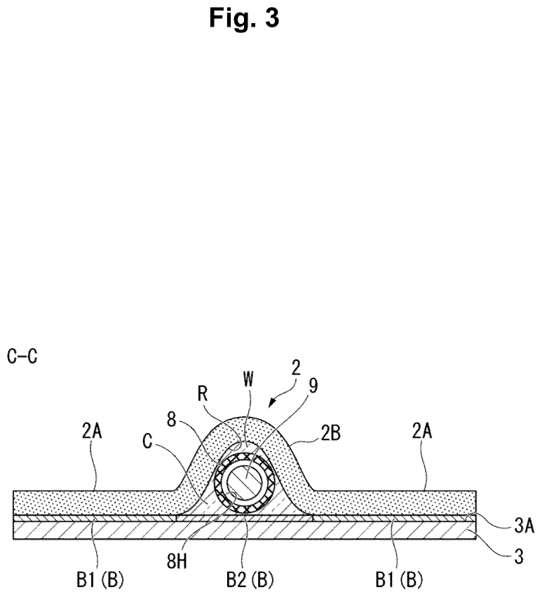

As illustrated in FIGS. 1 to 3, an optical waveguide device 100 includes a hybrid channel 1 in which a liquid channel is formed, optical fibers 9 connected to the hybrid channel 1, and liquid feed tubes 8 covering the optical fibers 9 respectively and connected to the hybrid channel 1.

The hybrid channel 1 is an optical waveguide whose waveguide characteristic of light is changeable in response to a stimulus. The hybrid channel 1 includes a solid substrate 3 formed into a plate shape and a soft material 2 provided on the one surface 3A side of the solid substrate 3.

The solid substrate 3 is formed into, for example, a rectangular plate shape. The solid substrate 3 is formed of, for example, a glass plate. The material of the solid substrate 3 will be described below. An adhesive layer B is formed on the one surface 3A side of the solid substrate 3. The adhesive layer B has, for example, a pair of rectangular adhesive regions B1 to which an adhesive agent is applied and a non-adhesive region B2, formed between the pair of adhesive regions B1, to which no adhesive agent is applied. The pair of adhesive regions B1 are formed, for example, so as to be separated by a predetermined width and extend along a predetermined direction on the one surface 3A side of the solid substrate 3.

That is, the non-adhesive region B2 having a predetermined width to which no adhesive agent is applied is formed between the pair of adhesive regions B1. Thus, the non-adhesive region B2 is formed with a predetermined width on the one surface 3A side of the solid substrate 3.

The soft material 2 is attached to the adhesive layer B. The soft material 2 is formed into a rectangular film shape. The soft material 2 is formed to include a gel substance having swellability. Swelling refers to a state of a gel substance as a constituent element that increases in volume by absorbing a solvent. The soft material 2 has plasticity and flexibility.

In the soft material 2, a pair of flat parts 2A adhered to the pair of adhesive regions B1 and a protruding part 2B formed in the non-adhesive region B2 are formed. The pair of flat parts 2A are fixed to the one surface 3A side of the solid substrate 3 via the pair of adhesive regions B1. As described below, the protruding part 2B is formed of the soft material 2 that swells by absorbing a solvent to protrude in the region of the non-adhesive region B2. For example, in a sectional view along the tube axis direction of a channel R, the protruding part 2B is formed so as to be gradually separated from the edge of one adhesive region B1 and curved to be proximal again to the edge of the other adhesive region B1 in the region of the non-adhesive region B2.

The protruding part 2B is formed so as to protrude from the one surface 3A of the solid substrate 3. Between the protruding part 2B and the non-adhesive region B2, a space is formed that serves as the channel R along the longitudinal direction of the non-adhesive region B2. At both ends of the protruding part 2B, a pair of openings R1 of the channel R are formed. To the pair of openings R1, one ends of a pair of liquid feed tubes 8 formed into a tubular shape are connected respectively. In the openings R1, the liquid feed tubes 8, and the connection parts, an adhesive agent C is filled so that each gap between the opening R1 and the liquid feed tube 8 is filled with the adhesive agent C.

The protruding part 2B is constrained by the pair of adhesive regions B1, so that the soft material 2 swells in the tube axis direction of the channel R and buckles as described below, and thus the channel R is formed into a wave shape along the tube axis direction (see Non Patent Literature 4 and Patent Literature 1). The curvature and the width of the wave-shaped channel R change in response to the degree of swelling of the soft material 2.

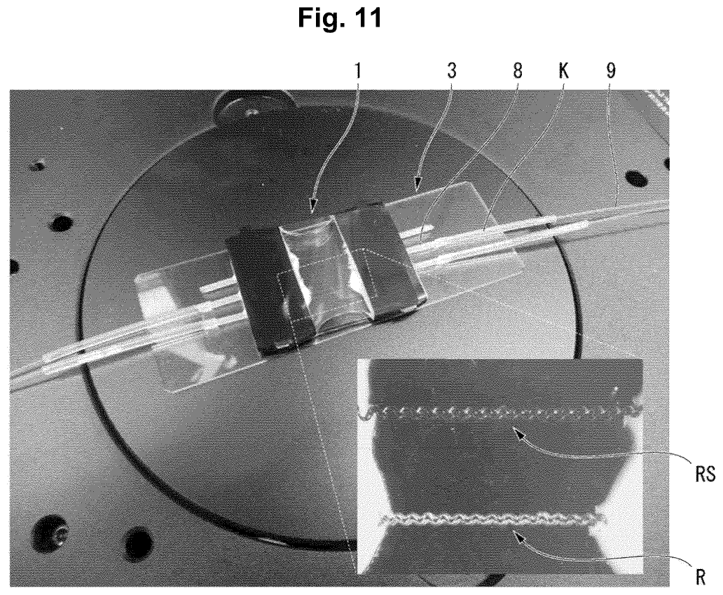

In each liquid feed tube 8, a through hole 8H is formed along the tube axis. The through hole 8H is formed to have a diameter larger than the outer diameter of the optical fiber 9. The optical fiber 9 is inserted through the through hole 8H. The optical fiber 9 is inserted to the connection part between the liquid feed tube 8 and the opening R1. A gap is formed between the optical fiber 9 and the through hole 8H. A liquid, described below, having an adjusted refractive index flows into the channel R from the gap. The channel R and the gap are filled with a liquid W. To the other end side of the liquid feed tube 8, one end side of a silicon tube K (see FIG. 11) is connected. The liquid feed tube 8 and the silicon tube K are formed to have a predetermined length so as to store a predetermined amount of the liquid W.

On the other end side of the silicon tube, a gap is formed between the optical fiber 9 and the opening of the silicon tube K. The gap between the opening of the silicon tube K and the optical fiber 9 may be open or may be filled with an adhesive agent or the like.

When the shape of the channel R is changed as described below, the liquid feed tube 8 supplies the liquid W into the channel R and stores the liquid W discharged from the channel R. The liquid feed tube 8 makes the liquid W flow into and out of the channel R in response to a volume change of the protruding part 2B. With the above configuration, an optical waveguide is formed as the hybrid channel 1 in which a core material is formed of the liquid in the channel R and a cladding material is formed of the film-shaped soft material 2.

Hereinafter, a material of each constituent of the optical waveguide device 100 will be described.

For example, the soft material 2 is formed to have swellability into a film shape using a hydrogel that can swell with an aqueous solvent. Alternatively, the soft material 2 may be formed to have swellability into a film shape using an organogel (elastomer) that can swell with a lipophilic solvent.

As the hydrogel, a synthetic water-soluble polymer such as polyacrylamide or polyvinyl alcohol, a polysaccharide such as chitosan, alginic acid, or cellulose, or a crosslinked protein such as collagen or albumin is used.

The kind of the material of the hydrogel is not particularly limited. The hydrogel is formed to include, for example, a stimulus-responsive material having responsiveness to an external stimulus. The responsiveness to an external stimulus means that the state of a subject changes in response to a stimulus given from the outside of the subject. The stimulus given to the subject is given, for example, by varying various parameters in its surrounding environment, such as light, heat, solvents, chemicals, magnetic fields, pH, electricity, atmospheric pressure, and water pressure. Examples of the change in the state of the subject include changes in physical properties including volume, shape, elasticity, water content, chemical properties, electromagnetic properties, optical properties, thermal conductivity, electrical properties, structural properties, and biological properties.

The hydrogel may be formed so that its degree of swelling changes in response to a thermal stimulus. For example, in the case of a hydrogel that responds to heat, a gel including poly(N-isopropylacrylamide) or poly(methyl vinyl ether) is used as the hydrogel. For example, in the case of a hydrogel that responds to pH, a gel including a polyelectrolyte synthesized from an anion or cation monomer is used as the hydrogel.

The hydrogel may be formed so that its degree of swelling changes in response to a light stimulus. For example, in the case of a hydrogel that responds to light, a gel including a polymer having a skeleton including spiropyran or azobenzene is used as the hydrogel. The hydrogel may be formed so that its degree of swelling changes in response to a light stimulus with an inclusion complex of azobenzene and cyclodextrin as a crosslinking point.

Furthermore, the hydrogel may be formed by mixing a plurality of base materials described above so as to respond to a plurality of stimuli differently. As the hydrogel, a tough hydrogel may be used such as a double network gel, a slide-ring gel, a Tetra-PEG gel, or a nanoclay gel.

The soft material 2 may be formed so as to have biocompatibility. The soft material 2 having biocompatibility is combined with a cell or a microorganism, and thus used as a material for production of a biodevice. The kind of the soft material 2 having biocompatibility is not particularly limited.

In a case where the soft material 2 having biocompatibility is obtained by embedding a cell or a microorganism in a film, the soft material 2 is formed using, as a base material, a hydrogel including a protein such as collagen and a polysaccharide such as agar or sodium alginate. The method of crosslinking in the soft material 2 having biocompatibility is not particularly limited. For example, a method of crosslinking may be used such as chemical crosslinking with glutaraldehyde or the like, or physical crosslinking such as hydrophobic bonding or ionic bonding with a polyvalent ion.

In a case where a cell or a microorganism is cultured in the film of the soft material 2, the hydrogel surface may be modified with a biocompatible molecule such as collagen, fibronectin, or laminin. As the modification method, for example, a method may be used in which the polymer on the hydrogel surface and the biocompatible molecule are chemically immobilized using a crosslinking agent such as sulfosuccinimidyl 6-(4′-azido-2′-nitrophenylamino)hexanoate, or a method may be used in which the biocompatible molecule enters the surface layer of the hydrogel and thus the surface layer physically adsorbs the biocompatible molecule.

The method of synthesizing the hydrogel is not particularly limited. In the case of forming an acrylic polymer as the hydrogel, chemical crosslinking by a polymerization reaction of acrylic groups may be used. In the case of forming a polysaccharide and a protein as the hydrogel, gelation by physical bonding may be used, or a chemical crosslinking agent represented by glutaraldehyde may be used.

The kind of the polymerization reaction is not particularly limited. As the polymerization reaction, for example, radical polymerization may be used in which a water-soluble photopolymerization initiator is used. For example, a water-soluble photoinitiator may be used such as 2-oxoglutaric acid, 4′-(2-hydroxyethoxy)-2-hydroxy-2-methylpropiophenone (Irgacure 2959), lithium phenyl(2,4,6-trimethylbenzoyl)phosphinate (LAP), or 2,2′-azobis[2-methyl-N-(2-hydroxyethyl)propionamide] (VA-086).

Furthermore, as the polymerization reaction, radical polymerization may be used in which a thermal polymerization initiator is used. As the thermal polymerization initiator, ammonium peroxodisulfate (APS), potassium peroxodisulfate (KPS), or the like may be used. The thermal polymerization initiator may be combined with N,N,N′,N′-tetramethylethane-1,2-diamine (TEMED) as a polymerization accelerator, and polymerized in a few minutes at room temperature. At this time, glucose and glucose oxidase may be added as a deoxidizing agent in order to prevent polymerization inhibition caused by oxygen, and the polymerization reaction may be performed after sufficient degassing in an atmosphere of an inert gas such as nitrogen or argon.

The shape of the stimulus-responsive gel is not particularly limited. The stimulus-responsive gel may be selected from those having various shapes according to the use form. The stimulus-responsive gel may be formed into, for example, a film shape, a plate shape, a block shape, or the like. In a case where channel-shaped deformation is to be induced, the stimulus-responsive gel is more preferably formed into a film shape among the above-described shapes so that large deformation can be induced with a small force.

The thickness of the film-shaped gel is not particularly limited. The film-shaped gel preferably has a thickness to maintain a structural strength such that the film-shaped gel is not crushed by its own weight. For example, in the case of using the above-described polyacrylamide gel, the film-shaped gel preferably has a thickness of 110 μm to 1000 μm, and more preferably 60 μm or more. The mechanical properties of the film-shaped gel can be improved by chemical crosslinking, physical crosslinking, or increase in the polymer concentration such that the strength enough to support its own weight is maintained while the thickness is maintained to be small.

In the case of using the polyacrylamide gel, the film-shaped gel preferably has a monomer concentration of 0.8 M to 8 M, and more preferably 2 M to 4 M. In the case of using methylene bisacrylamide for chemical crosslinking, the crosslinking concentration is preferably 0.01 to 2.0 mol %, and more preferably 0.03 to 1 mol % with respect to the monomer.

To the hydrogel, various additives may be added. The kind of the additive is not particularly limited as long as the additive does not inhibit hydrogel formation. For example, in the case of improving the biocompatibility, biomolecules, and silver nanoparticles and surfactants for expression of an antibacterial property may be used as the additive.

For example, in the case of increasing the conductivity, ionic liquids and conductive polymers may be used as the additive. For example, in the case of reacting the additive with a magnetic field, magnetic nanoparticles may be used as the additive. For example, in the case of introducing an optothermal function, graphene, graphene oxide, metal nanoparticles, polydopamine, and the like may be used as the additive. Optional functions are imparted to the hydrogel by adding the above-described additives having various functions.

The hydrogel is formed of, for example, a swellable organogel. As the swellable organogel (elastomer), silicone such as polydimethylsiloxane, synthetic rubber such as butadiene rubber, chloroprene rubber, isoprene rubber, acrylic rubber, and urethane rubber, natural rubber, thermoplastic resins such as polyethylene, polyvinylchloride, polypropylene, polystyrene, polymethyl methacrylate, and polyethylene terephthalate, and thermosetting resins such as phenolic thermosetting resins and epoxy thermosetting resins may be used.

The swellable organogel is swollen, for example, by immersing the swellable organogel in a swelling solvent. The swollen state can be changed in response to the kind and the concentration of the solvent. As the swelling solvent, various organic solvents capable of swelling various organogels (elastomers) may be used. As the swelling solvent, for example, methanol, ethanol, acetone, dimethylsulfoxide, dimethylformamide, ethyl acetate, chloroform, tetrahydrofuran, benzene, toluene, xylene, pyridine, carbon disulfide, ethylene glycol, glycerol, and the like may be used.

The kind of the organogel (elastomer) is not particularly limited. In the case of forming an organogel as the stimulus-responsive elastomer, for example, a liquid crystal elastomer may be used, and the organogel can be used as a deformation control device.

To the organogel (elastomer), various additives may be added. The kind of the additive is not particularly limited as long as the additive does not inhibit organogel (elastomer) formation. As the additive, for example, biomolecules for improvement in the biocompatibility, silver nanoparticles and surfactants for expression of an antibacterial property, ionic liquids and conductive polymers for increase in the conductivity, magnetic nanoparticles for reaction with a magnetic field, graphene, graphene oxide, metal nanoparticles, and polydopamine for introduction of an optothermal function, and the like may be added. Optional functions can be imparted to the organogel (elastomer).

Next, the material of the solid substrate 3 will be described.

The kind of the solid substrate 3 is not limited. As the solid substrate 3, for example, glass having excellent transparency and excellent chemical stability is used. For example, in the case of inducing large deformation with a mechanical stimulus, an elastomer such as polysilicone or synthetic rubber may be used as the solid substrate 3. In the case of inducing a thermal stimulus with a light stimulus, a film including a carbon nanotube, a gold nanostructure, a porphyrin derivative, polydopamine, indocyanine green, or the like may be used as the solid substrate 3.

In the case of inducing a thermal stimulus with an electrical stimulus, a conductor or a magnetic metal body capable of inducing a thermal stimulus with a magnetic field stimulus may be used as the solid substrate 3. In the case of inducing an electrical stimulus with a mechanical stimulus, a piezoelectric element may be used as the solid substrate 3. In the case of inducing a light stimulus with an electrical stimulus, a light emitting diode may be used as the solid substrate 3.

Furthermore, the solid substrate 3 may be formed using a soft material 2 having a degree of swelling different from that of the soft material 2 to be combined. The shapes of these solid substrates are not particularly limited. The solid substrate 3 may be processed into a three-dimensional shape, with a microfabrication technique or the like, such that a stimulus can be transmitted more complicatedly. The mechanical properties of the solid substrate 3 are not particularly limited. In a case where the solid substrate 3 is formed so as to have a significantly higher rigidity modulus than the soft material 2, only the soft material 2 can be largely deformed to induce a large space in the non-adhesive region B2 in the solid substrate 3, and thus the shape of the hybrid channel 1 can be produced.

Next, an adhesion method of the film-shaped soft material 2 and the solid substrate 3 will be described.

The adhesion method of the soft material 2 and the solid substrate 3 is not particularly limited. As the adhesion method, a surface display method of an adhesive functional group using a silane coupling agent may be used. In the adhesion method, for example, 3-(methacryloyloxy)propyltrimethoxysilane is reacted with the surface of the solid substrate 3 activated by oxygen plasma or piranha cleaning, and thus a methacrylic group as a radical polymerization reactive group can be displayed on the surface. The soft material 2 is synthesized on the solid substrate 3 by radical polymerization to obtain a soft material laminate in which the soft material 2 and the solid substrate 3 are adhered to each other.

When 3-(methacryloyloxy)propyltrimethoxysilane is displayed on the surface of the solid substrate 3, any pattern may be drawn with a photoresist using a lithographic technique. With the photoresist, the methacrylic groups on the substrate surface are disposed in any arrangement, and thus the soft material 2 and the solid substrate 3 can be adhered to each other with a pattern.

In a case where the solid substrate 3 is formed of an elastomer, such as polysilicone or synthetic rubber, that can be infiltrated by an organic solvent and in a case where the solid substrate 3 is formed of an organic substrate such as a polymer film, an adhesion method is as follows. A solution obtained by dissolving a hydrogen abstraction type photoinitiator (such as benzophenone, Michler's ketone, or Michler's ethyl ketone) in an organic solvent (such as ethanol or acetone) is applied to the surface of the solid substrate 3 formed of an organic substrate. Thereafter, the hydrogen abstraction type initiator and the soft material 2 are radically polymerized on the surface of the solid substrate 3. At this time, a radical reaction starting point is generated on the surface of the solid substrate 3 by the hydrogen abstraction mechanism of the hydrogen abstraction type initiator, and therefore the solid substrate 3 and the soft material 2 can be adhered to each other by a covalent bond.

Before the polymerization of the soft material 2, the organic substrate may be irradiated with a patterned UV light source to react the included hydrogen abstraction type initiator and remove the adhesion ability of the irradiated site, and thus the organic substrate and the soft material may be adhered to each other with a pattern. Alternatively, a lithographic technique may be used for the substrate to display a water-repellent and oil-repellent functional group (such as trichloro(1H,1H,2H,2H-heptadecafluorodecyl)silane) in advance at any position on the surface of the base material, and the substrate may be immersed in a hydrogen abstraction type initiator-containing ethanol solution. In this case, the hydrogen abstraction type initiator is not introduced onto the water-repellent and oil-repellent functional group and thus the water-repellent and oil-repellent functional group has no polymerization ability, and therefore the solid substrate 3 and the soft material 2 are adhered to each other with a pattern.

In the case of adhering a molded soft material 2 to any solid substrate 3, examples of the adhesion method include a method in which a network interpenetrating polymer is displayed on the solid substrate 3. The display method is not particularly limited. A reactive functional group is displayed on the surface of the solid substrate 3 with a silane coupling agent, and the grafting to method or the grafting from method may be used to bond the interpenetrating polymer to the reactive functional group.

The solid substrate 3 and the molded soft material 2 may be brought into contact with each other to make the interpenetrating polymer penetrate into the network, and may be entangled with the network to form a physical or chemical bond, and thus the soft material 2 and the solid substrate 3 may be adhered to each other.

The above-described reactive functional groups may be disposed on the surface of the above-described solid substrate 3 in any arrangement using a lithographic technique, and thus the soft material 2 and the solid substrate 3 may be adhered to each other with a pattern. The interpenetrating polymer is not particularly limited. After the interpenetrating polymer penetrates into the network such as chitosan, alginic acid, or polyvinyl alcohol, a pH change and a low-molecular crosslinking agent represented by glutaraldehyde may be simultaneously diffused. As a result, a physical bond or a chemical bond between the interpenetrating polymers can be formed to adhere the soft material 2 and the solid substrate 3 to each other more firmly.

Alternatively, a cyanoacrylate-based adhesive agent may be applied to the solid substrate 3, and the molded soft material 2 may be brought into contact with the solid substrate 3. As a result, anionic polymerization of the cyanoacrylate monomer starts using moisture in the network or in the air as an initiator, and the soft material 2 and the solid substrate 3 can be firmly adhered to each other.

The size scale of the adhesion with a pattern is not particularly limited within the scope of a lithographic technique. The method of lithography is not particularly limited. As the method of lithography, methods may be used such as a method in which a photomask is used, a method in which a patterned UV light source is used, and micro contact patterning (μCP) in which a pattern is formed in advance with an elastic material such as polydimethylsiloxane and a chemical substance is transferred in the manner of a stamp.

Next, the liquid feed tube 8 and a method of joining the liquid feed tube 8 will be described.

The kind of the liquid feed tube 8 is not particularly limited. As the liquid feed tube 8, for example, a tube may be used that is formed into a tubular shape with polytetrafluoroethylene (PTFE), tetrafluoroethylene (PFA), polyurethane, polyethylene, silicone, polyimide, or the like.

The outer diameter of the liquid feed tube 8 is not particularly limited. The liquid feed tube 8 is desirably formed so as to have an outer diameter substantially equal to the height of the channel R. The inner diameter of the liquid feed tube 8 is not particularly limited. The liquid feed tube 8 is desirably formed so as to have an inner diameter such that an optical fiber can be inserted into the liquid feed tube 8, and the inner diameter is preferably about 0.5 to 1 mm.

The adhesive agent for fixing of the liquid feed tube 8 and the hybrid channel 1 desirably has solvent resistance and bonds to the base material and the hydrogel. As the adhesive agent, for example, an adhesive agent may be used such as a cyanoacrylate-based adhesive agent, a silicone-based adhesive agent, or an epoxy-based adhesive agent.

Next, the high refractive index liquid (liquid W) filled into the channel R will be described.

The kind of the high refractive index liquid is not particularly limited. The high refractive index liquid needs to be a liquid having a higher refractive index than the hybrid channel 1 including the swellable soft material and the solid substrate in order to confine light with high efficiency. In the hybrid channel 1, an optical waveguide is formed in which the non-adhesive region B2 and the soft material 2 are formed into a cladding, and the high refractive index liquid surrounded by the non-adhesive region B2 and the soft material 2 is formed into a core.

For example, in the soft material 2 formed using a hydrogel having swellability, a large part of the constituent components is water (refractive index: 1.333), and therefore the soft material 2 shows a refractive index value close to the refractive index value of water. For example, in the case of 10 wt % polyacrylamide, the refractive index is about 1.35.

The solid substrate 3 may be formed of soda-lime glass (refractive index: 1.51), a Si substrate (refractive index: 3.41), silicone rubber (refractive index: 1.41), polymethyl methacrylate (refractive index: 1.49), or the like. In the case of the solid substrate 3 having a too high refractive index, the surface can be coated with an amorphous fluororesin (such as amorphous fluoropolymer or Teflon (registered trademark) AF) to form a low refractive index layer (refractive index: 1.3 or less) on the surface.

There are various kinds of high refractive index liquids. As the high refractive index liquid, a solvent is desirably used that does not mix with (has low compatibility with) the solvent inside the soft material 2. For example, in the case of enclosing the high refractive index liquid in the hybrid channel 1 formed of a hydrogel (the soft material 2) and glass (the solid substrate 3), a liquid that does not mix with water in the hydrogel (hydrophobic liquid) is desirable.

As the high refractive index liquid, for example, silicone oil (refractive index: 1.40), chloroform (refractive index: 1.4429), kerosene (refractive index: 1.4465), coconut oil (refractive index: 1.45), cacao butter (refractive index: 1.456), carbon tetrachloride (refractive index: 1.46), olive oil (refractive index: 1.466), paraffin oil (refractive index: 1.48), mineral oil (refractive index: 1.48), toluene (refractive index: 1.49), benzene (refractive index: 1.50), cedar oil (refractive index: 1.516), aniline (1.586), 1-bromonaphthalene (refractive index: 1.658), methylene iodide (refractive index: 1.74), or the like may be used.

In the case of enclosing the high refractive index liquid in a lipophilic solvent-containing organogel-based hybrid channel, a hydrophilic liquid is desirably used. For example, as the high refractive index liquid, a 10% sugar solution (refractive index: 1.348), a 10% salt solution (refractive index: 1.35), a 20% sugar solution (refractive index: 1.364), acetic acid (refractive index: 1.37), glycerin (refractive index: 1.473), an 80% sugar solution (refractive index: 1.49), or the like may be used.

The high refractive index liquid in which a functional substance is dissolved or dispersed can have a function further added. For example, a dye may be dissolved or dispersed in the high refractive index liquid. The high refractive index liquid having a dye can be applied as a core material capable of filtering or sensing light having a specific wavelength. In the high refractive index liquid, metal nanoparticles may be dispersed. The high refractive index liquid having metal nanoparticles can be applied as a sensing core material utilizing surface plasmon resonance (SPR). Furthermore, the high refractive index liquid in which a fluorescent material is dissolved or dispersed can be used as a light-emitting core, and can also be used as a micro light source in optofluidics.

Next, changing the shape of the waveguide structure in the optical waveguide will be described.

In the optical waveguide device 100, a liquid is used in the core in the optical waveguide, and therefore the core shape, that is, the waveguide structure can change by following the shape change of the cladding. In the optical waveguide device 100, the channel R serving as a cladding includes a swellable soft material and is formed so as to be deformable with a large amount of solvent and a three-dimensional network polymer, and the shape can be controlled by a volume change caused by inflow and outflow of the solvent.

The inflow and the outflow of the solvent in the channel R can be induced by an external stimulus. The inflow and the outflow of the solvent can induce a shape change with various stimuli such as a solvent, heat, light, a magnetic field, pH, and an electric field according to the polymer to be used.

For example, in the case of using a neutral gel such as a polyacrylamide gel as the cladding, immersing the device in an organic solvent such as ethanol or acetone causes outflow of the moisture in the gel, and as a result, the shape of the cladding (channel R) can be contracted. Furthermore, immersing the device in an aqueous solution containing a molecule such as urea that breaks a hydrogen bond between side chains in polyacrylamide causes inflow of moisture into the gel, and the shape of the cladding (channel R) can be expanded. These shape changes can be reversibly controlled by restoring the composition of the solvent.

For example, in the case of using a temperature-responsive gel such as a poly-N-isopropylacrylamide gel as the cladding, raising the temperature causes outflow of the moisture in the gel, and the shape of the cladding (channel R) can be contracted. The temperature in the gel of the cladding may be raised with a method in which a photothermal conversion material is combined to induce a temperature rise by irradiation with light having an appropriate wavelength. As the photothermal conversion material, for example, metal nanomaterials such as gold nanoparticles and nanorods that generate heat by absorbing near-infrared light (800-2500 nm), carbon nanomaterials such as graphene and graphene oxide that can heat by absorbing a microwave, and conductive polymers such as PEDOT/PSS and polyaniline may be used.

The cladding may be combined with a conductive material such as a metal, carbon, or a conductive polymer, and induction-heated by applying an alternating magnetic field. The shape change of the cladding caused by heating can be reversibly controlled by restoring the temperature of the gel.

For example, in the case of using, as the cladding, a photoresponsive gel having a side chain having a photochromic functional group such as spiropyran, the cladding may be irradiated with light having an appropriate wavelength (ultraviolet light) to photoisomerize the side chain. The polarity inside the gel increases, and as a result, moisture flows into the gel, and the shape of the cladding can be expanded. In the case of using, as the cladding, a photoresponsive gel including an inclusion complex of azobenzene and cyclodextrin as a crosslinking point, the cladding may be irradiated with light having an appropriate wavelength (ultraviolet light). The irradiation with light causes dissociation of the inclusion complex due to photoisomerization of azobenzene, and moisture flows into the gel to expand the shape of the cladding. These shape changes can be reversibly controlled by restoring photoisomerization by visible light-irradiation or a temperature rise.

For example, in the case of using, as the cladding, an electrolyte polymer gel such as polyacrylic acid, the device may be immersed in an acid or an alkaline solution. As a result, the degree of dissociation of the electrolyte functional group in the side chain changes, the osmotic pressure in the gel increases and decreases, and the solvent flows in and out to expand and contract the shape of the cladding. These shape changes can be reversibly controlled by restoring the pH of the solvent.

Next, a method of producing an optical waveguide device 100 will be described.

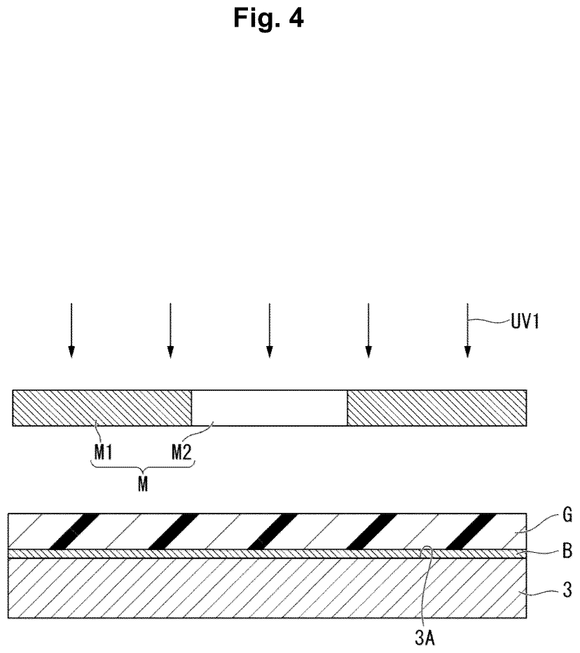

As illustrated in FIG. 4, an adhesive layer B is formed of an adhesive functional group on one surface 3A side of a solid substrate 3, and a resist layer G is formed on a surface, opposite from the solid substrate 3, of the adhesive layer B. First, a solid substrate 3 formed of glass to have a predetermined size is washed with a sodium hydroxide aqueous solution. The surface of the washed solid substrate 3 is treated with oxygen plasma and activated.

The solid substrate 3 whose surface is activated is treated with a radically reactive silane coupling agent to obtain the solid substrate 3 on which an adhesive layer B is formed of an adhesive functional group that is a monolayer of the silane coupling agent. On the surface of the adhesive layer B, a resist layer G formed of a positive photoresist into a thin film shape is produced by spin coating. The positive photoresist is formed so that an exposed portion dissolves in a developer and an unexposed portion remains.

Thereafter, the solid substrate 3 coated with the resist layer G is irradiated with an ultraviolet ray UV1 through a mask M having a light-shielding parts M1 and a light-transmissive part M2. In the light-transmissive part M2, for example, a dumbbell-shaped pattern is formed that has a line width at both ends of 2 mm and a line width of 500 μm. The solid substrate 3 is irradiated with the ultraviolet ray UV1 through the light-transmissive part M2, and thus the pattern is developed. After the irradiation with the ultraviolet ray UV1, for example, a resist layer G is formed, on the solid substrate 3, in which the positive photoresist is removed only in the dumbbell-shaped portion having a line width at both ends of 2 mm and a line width of 500 μm.

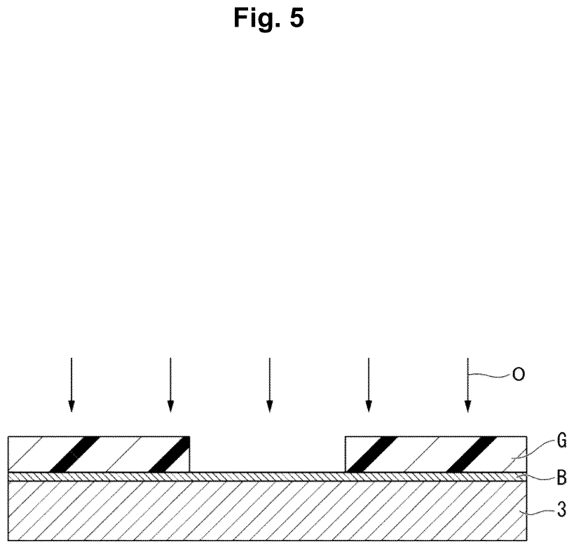

As illustrated in FIG. 5, the surface of the solid substrate 3 on which the pattern is formed is treated with oxygen plasma, the portion without the resist layer G is washed, and at this portion, the adhesive layer B of the adhesive functional group is peeled off.

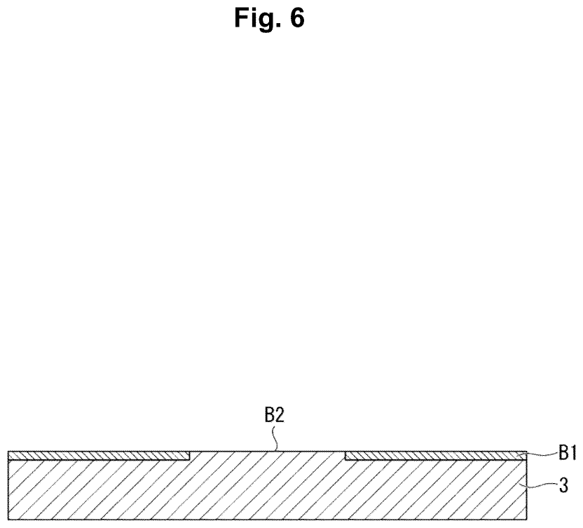

As illustrated in FIG. 6, on the surface of the solid substrate 3, the resist layer G is lifted off with acetone. As a result, the solid substrate 3 is obtained in which adhesive regions B1 and a non-adhesive region B2 are formed. In the drawings, for the sake of convenience, the adhesive regions B1 and the non-adhesive region B2 are illustrated on the same plane, but the actual non-adhesive region B2 is formed to have a thickness extremely thin to a negligible extent. Thereafter, polymerization for a polyacrylamide gel is performed on the surface of the solid substrate 3 obtained with the above-described method to form a hydrogel layer.

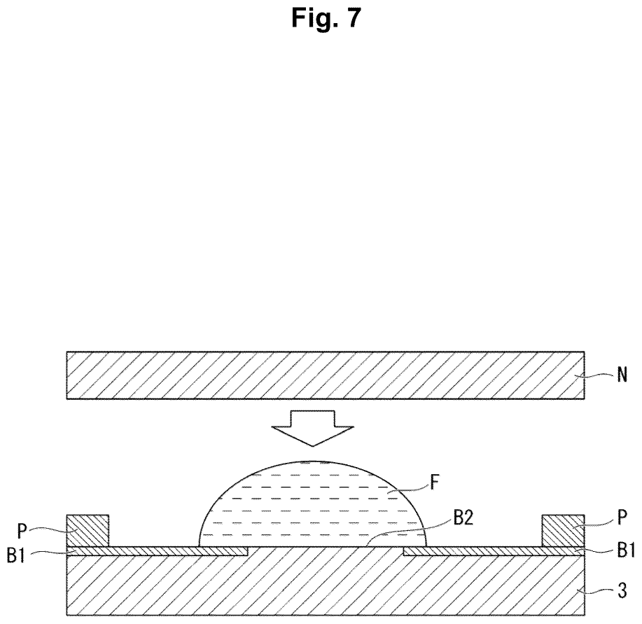

As illustrated in FIG. 7, a pair of spacers P having a thickness of 60 μm are disposed at both ends of the solid substrate 3. Thereafter, a solution containing acrylamide as a monomer, fluorescein-o-acrylate as a fluorescent monomer, methylenebisacrylamide as a crosslinking agent, and LAP as a photopolymerization initiator (hereinafter, referred to as gel precursor solution F) is dripped on the solid substrate 3.

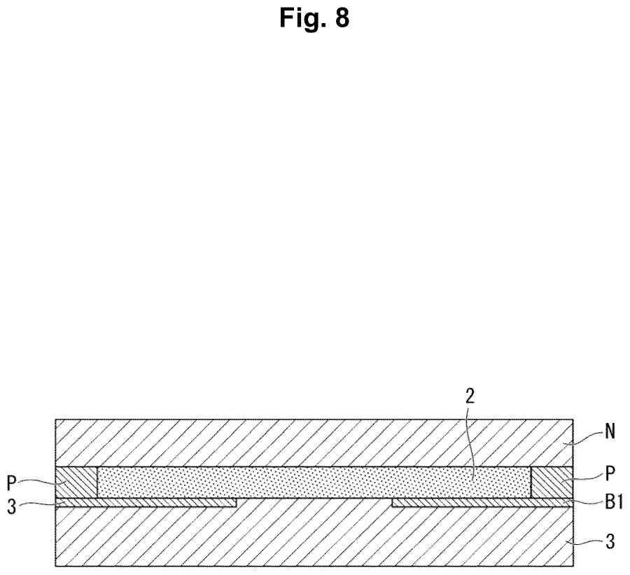

As illustrated in FIG. 8, a cover glass subjected to oxygen plasma treatment (hereinafter, referred to as seal substrate N) is placed from the upper side of the solid substrate 3. The gel precursor solution F is sandwiched between the solid substrate 3 and the seal substrate N, and the excess gel precursor solution F extruded from between the solid substrate 3 and the seal substrate N is wiped and removed with a nonwoven fabric or the like. The solid substrate 3 and the seal substrate N to which the gel precursor solution F is applied are allowed to stand at room temperature, and the gel precursor solution completely gels to form a hydrogel (soft material 2).

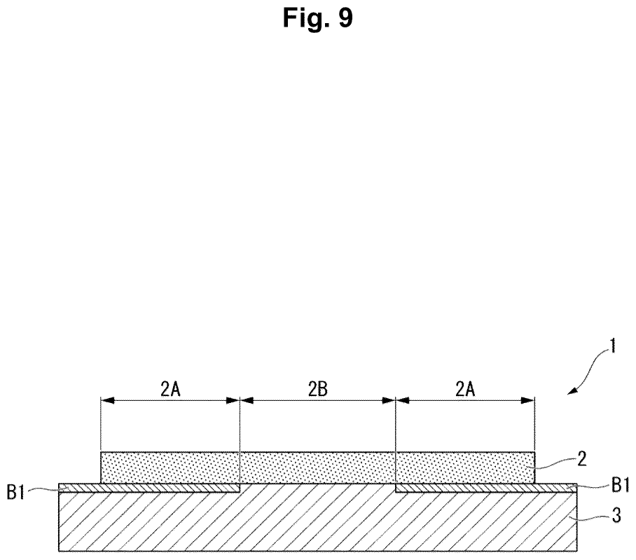

As illustrated in FIG. 9, after the gelation, the seal substrate N and the spacers P are removed from the solid substrate 3. As a result, the film-shaped soft material 2 is formed in a state of being attached to the one surface 3A side of the solid substrate 3. The solid substrate 3 is immersed in a large excess amount of a pure aqueous solution. Unreacted gel precursor molecules are removed from the solid substrate 3. As a result, a hybrid channel 1 is obtained that has the soft material 2 formed into a film shape and the solid substrate 3.

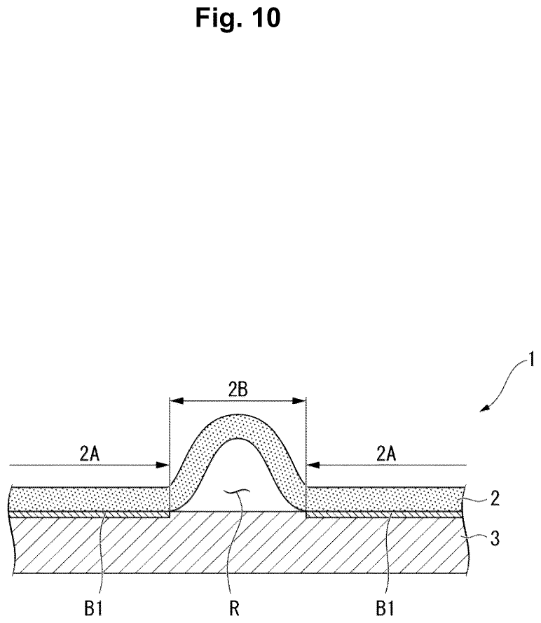

As illustrated in FIG. 10, the soft material 2 swells when only a region corresponding to the non-adhesive region B2 interacts with a liquid, and deforms from a planar shape to a protruding part 2B having a three-dimensional channel R. Thereafter, PTFE tubes (liquid feed tubes 8) formed to have an outer diameter of 1 mm are inserted into both ends of the channel R. The PTFE tubes, the glass substrate, and the film-shaped hydrogel are adhered using a silicone-based adhesive agent, and an optical waveguide device 100 to which liquid feeding and optical fibers can be coupled is obtained.

As shown in FIG. 11, silicon tubes K are connected to the PTFE tubes, and mineral oil used as a high refractive index liquid is fed and enclosed in the channel R. A comparison target is also prepared in which pure water is enclosed in the channel RS. Resin optical fibers (outer diameter: 0.5 mm) are inserted into the silicon tubes K and the PTFE tubes at both ends, and the optical waveguide device 100 is obtained in which an optical waveguide is formed of the soft material 2 such that light can enter the hybrid channel.

Next, a result of observing the three-dimensional structure of the optical waveguide using a fluorescence microscope will be described.

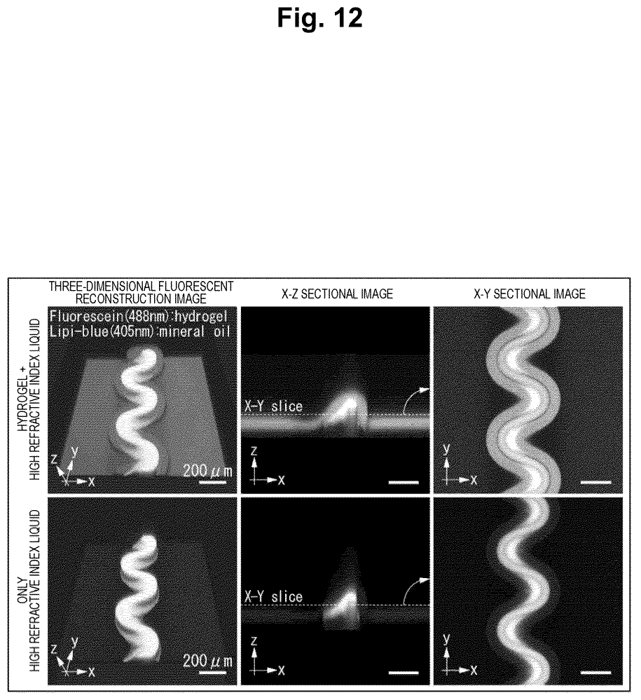

As shown in FIG. 12, in the optical waveguide device 100 in which the soft material obtained with the above-described method is used, the hydrogel is colored with a fluorescent label using fluorescein-o-acrylate, and the high refractive index liquid is colored with a fluorescent label using Lipi-Blue (1 mM) as a hydrophobic fluorescent dye. When a sectional observation image of the soft material 2 in the protruding part 2B is photographed using a confocal fluorescence microscope, a film-shaped hydrogel fluorescently stained in green and a high refractive index liquid fluorescently stained in blue are observed. The state of the optical waveguide device 100 was observed in which a cladding layer including a hydrogel (soft material 2) and glass (solid substrate 3) and a core layer including a high refractive index liquid were constructed.

The protruding part 2B is constrained by a pair of adhesive regions B1 when the protruding part 2B swells, and therefore the portion swollen in the tube axis direction of the channel R buckles to form the protruding part 2B into a wave-shaped channel R along the tube axis direction. The curvature and the width of the wave-shaped channel R change in response to the degree of swelling of the soft material 2, which changes in response to a stimulus of a solvent. In response to the formation of the wave-shaped channel R, the shape of the liquid filled inside also changes to a wave shape.

Next, a method of controlling the shape of the waveguide structure by applying a stimulus to the optical waveguide device 100 from the outside will be described.

In the optical waveguide device 100 having the soft material 2 obtained with the above-described method, the protruding part 2B is formed so that the shape changes in response to a stimulus applied from the outside, and is formed so that the optical path length of the channel R changes in response to the shape change.

For example, the shape of the protruding part 2B may change in response to a property of the surrounding solvent as a stimulus to change an optical waveguide characteristic. In the optical waveguide device 100, for example, the shape of the protruding part 2B may change in response to a property of the solvent to change the optical path length and change an optical waveguide characteristic.

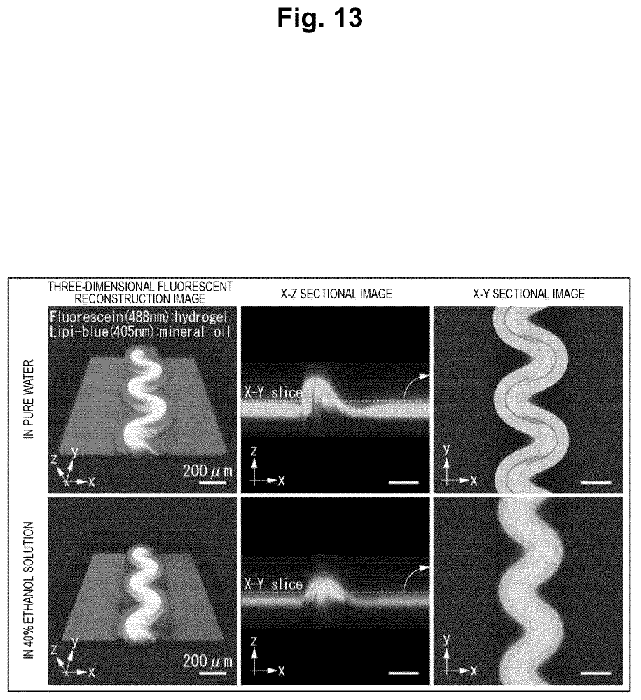

As shown in FIG. 13, in the case of immersing the optical waveguide device 100 in a 40% ethanol solution as a solvent stimulus, the degree of swelling of the hydrogel in the soft material 2 is low as compared with the case of immersing the optical waveguide device 100 in pure water. In the protruding part 2B, the soft material 2 swells in the tube axis direction of the channel R and buckles, and thus the channel R is formed into a wave shape along the tube axis direction.

In the protruding part 2B, shape changes of the wave-shaped channel R, such as a change in the curvature and a change in the width, were observed in response to a change in the volume that is caused in response to a change in the solvent stimulus. At this time, a state was observed in which the shape of the high refractive index liquid as the core layer changed following the shape change of the hydrogel as the cladding layer.

Next, an example will be described in which the optical waveguide device 100 is applied to optical waveguiding.

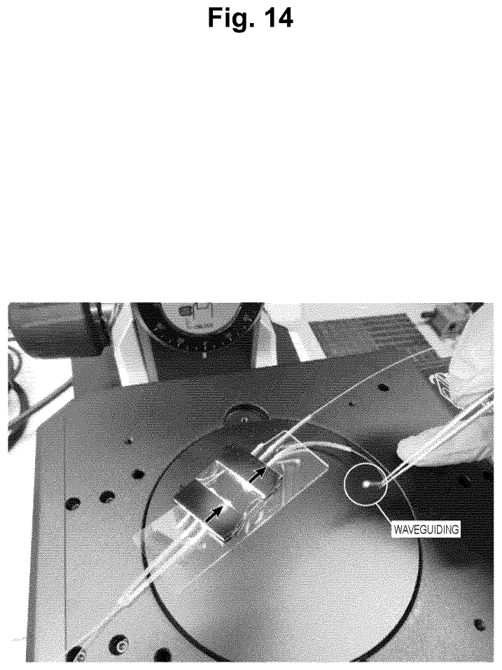

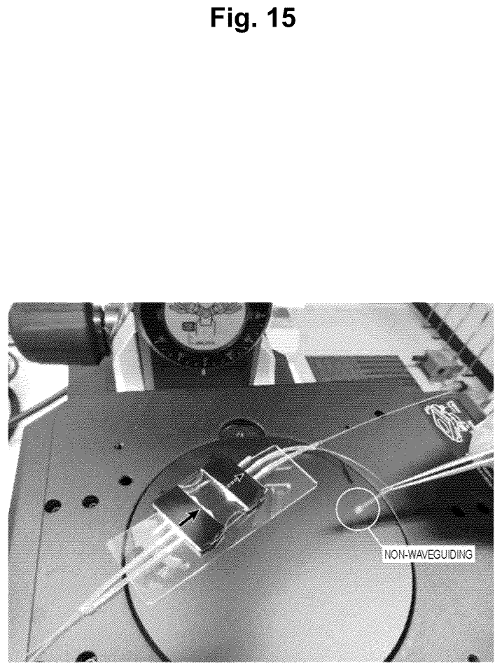

As shown in FIGS. 14 and 15, the state of the optical waveguiding in the optical waveguide device 100 having the soft material 2 is observed. In the optical waveguide device 100 having the soft material 2, mineral oil or pure water is enclosed in the hybrid channel 1 formed of a hydrogel and glass. Thereafter, light enters from the optical fiber, and the state of optical waveguiding in the optical waveguide device 100 according to the property of the liquid is observed.

In the optical waveguide device 100 filled with mineral oil, a state was observed in which light was guided to the end of the optical fiber on the outlet side (see FIG. 14). Meanwhile, in the optical waveguide device 100 filled with pure water, the state was not observed in which light was coupled to the end of the optical fiber on the outlet side (see FIG. 15). That is, according to the optical waveguide device 100, a configuration may be employed in which light is guided or not guided according to the kind of the liquid filled in the channel R in the protruding part 2B. According to the optical waveguide device 100, application to a switching circuit in optical waveguiding is possible.

The optical waveguide device 100 having the soft material 2 according to the present invention is useful as a sensing device, a switching device, and an energy transmission device that make use of the variability of a liquid core, and can be widely applied to a wide range of fields of optofluidics, biosensors, lab-on-a-chip devices, molecular imaging, energy, and the like.

As described above, according to the optical waveguide device 100, the hybrid channel 1 is formed using the soft material 2 formed from various chemical species into a film shape, and a liquid having a high refractive index is enclosed in the hybrid channel 1 to form a core, and thus an optical waveguide can be formed.

According to the optical waveguide device 100, an optofluidics device in which various functions are combined can be produced particularly by individually selecting the kind of each of the soft material 2 formed into a film shape and the liquid core. For example, by using a hydrogel capable of reversibly changing its volume in response to a stimulus in the soft material 2 formed into a film shape, application is possible to a switch device capable of changing the shape of an optical waveguide and switching between optical waveguiding and non-waveguiding. According to the optical waveguide device 100, application is possible to a sensing device capable of changing the shape of the optical waveguide in response to a stimulus and changing the optical path length.

According to the optical waveguide device 100, the degree of volume change of the hydrogel is adjusted so as to change the optical path length, and thus application is possible to a Mach-Zehnder interferometer or a sensor that senses various stimuli. According to the present invention, a channel shape is designed so that light leaks from a waveguide, or an evanescent wave is used that has a property of leaking to a low refractive index medium side, and thus a light stimulus can be applied to the inside or the periphery of a hydrogel thin film.

At this time, a cell culture device capable of accepting a light stimulus can be constructed by selecting a hydrogel thin film having biocompatibility and by culturing cells on or in the hydrogel thin film. For example, when a photoreactive cell obtained by introducing a rhodopsin protein into a living cell by genetic manipulation is applied to a cell culture device, a sensor device can be constructed in which optogenetics is utilized. In addition, when a photosynthesis microorganism represented by cyanobacteria is applied to a cell culture device, a bioreactor capable of converting light energy into chemical energy can be constructed.

In addition, according to the optical waveguide device 100, various sensor devices can be constructed by incorporating a material that interacts with light (such as graphene, a metal nanoparticle, or a fluorescent dye) into the inside of the hydrogel or the solute of the liquid core.

As above, the embodiments of the present invention have been described in detail with reference to the drawings. On the other hand, the specific configuration is not limited to the embodiments, and includes design and the like without departing from the spirit of the present invention.

### INDUSTRIAL APPLICABILITY

The optical waveguide device in which the soft material according to the present invention is used can be applied to a sensing device, a switching device, and an energy transmission device that make use of the variability of a liquid core. The optical waveguide device can be widely applied to a wide range of fields of optofluidics, biosensors, lab-on-a-chip devices, molecular imaging, energy, and the like.

### REFERENCE SIGNS LIST

1 Hybrid channel
2 Soft material
2A Flat part
2B Protruding part
3 Solid substrate
3A One surface
8 Liquid feed tube
8H Through hole
9 Optical fiber
100 Optical waveguide device
B Adhesive layer
B1 Adhesive region
B2 Non-adhesive region
C Adhesive agent
F Gel precursor solution
G Resist layer
K Silicon tube
M Mask
M1 Light-shielding part
M2 Light-transmissive part
N Seal substrate
P Spacer
R Channel
R1 Opening
RS Channel
W Liquid

1. An optical waveguide device comprising:
a substrate formed into a plate shape;
a soft material having swellability and formed into a film shape, the soft material provided on a side of one surface of the substrate;
a pair of adhesive regions formed so as to extend along a predetermined direction on the one surface at an interface between the substrate and the soft material, the pair of adhesive regions in which the substrate and the soft material are adhered to each other;
a non-adhesive region formed so that the substrate and the soft material are not adhered to each other between the pair of adhesive regions;
a protruding part in which a channel is formed so as to protrude in the non-adhesive region in the soft material;
a liquid filled into the channel and having a higher refractive index than the soft material;
a pair of liquid feed tubes connected to both ends of the channel; and
a pair of optical fibers inserted into the pair of liquid feed tubes respectively, wherein
an optical waveguide is formed in the protruding part, the optical waveguide including a cladding formed of the soft material, and including a core formed of the liquid in the channel.

2. The optical waveguide device according to claim 1, wherein
the protruding part is formed so that a physical property changes in response to a stimulus given from an outside.

3. The optical waveguide device according to claim 1, wherein
the protruding part is formed so that a volume changes in response to a property of a solvent in contact with surrounding of the protruding part, and is formed so as to change a waveguide characteristic of light by a change in a shape of the liquid filled in the channel in response to the volume change.

4. The optical waveguide device according to claim 1, wherein
the protruding part is formed so as to guide light or not to guide light in response to a kind of the liquid filled in the channel.

5. The optical waveguide device according to claim 1, wherein
the soft material is formed so as to include a hydrogel that swells with an aqueous solvent.

6. The optical waveguide device according to claim 1, wherein
the soft material is formed so as to include an organogel that swells with a lipophilic solvent.

7. The optical waveguide device according to claim 1, wherein
the soft material is formed so as to swell in response to a light stimulus or a thermal stimulus.

8. The optical waveguide device according to claim 1, wherein
the soft material is formed so as to include a cell and/or a microorganism and have biocompatibility.
